(19) United States
(12) Patent Application Publication
(10) Pub. No.: US 2023/0359773 A1
(43) Pub. Date: Nov. 9, 2023

(54) DOCUMENT MANAGEMENT FOR CLOUD-BASED 5G NETWORKS

(71) Applicant: DISH Wireless L.L.C., Englewood, CO (US)

(72) Inventor: Steven Wilson, Englewood, CO (US)

(73) Assignee: DISH Wireless L.L.C., Englewood, CO (US)

(21) Appl. No.: 18/311,831

(22) Filed: May 3, 2023

Related U.S. Application Data
(60) Provisional application No. 63/338,347, filed on May 4, 2022.

(51) Int. Cl. G06F 21/62; G06F 21/56

(52) U.S. Cl. CPC G06F 21/6281; G06F 21/563

(57) ABSTRACT

Systems, methods, and devices secure executables in a cloud-based environment. An example process includes receiving a first pull request to create an executable document for execution by an instance running in the cloud-based environment. The executable document is stored in a document repository in response to the first pull request and approval of the executable document. A command is generated for a system manager in the cloud-based environment to create the executable document. A second pull request is received to create a script that is executable by the document. The script is stored in a script repository in response to the second pull request and an approval of the script. The executable document runs in response to a run command from the instance running in the cloud-based environment, and the approved script stored in the script repository runs in response to a call from the executable document.

### CROSS-REFERENCE TO RELATED APPLICATIONS

This application claims priority to U.S. Provisional Patent Application No. 63/338,347, filed on May 4, 2022, and entitled “DOCUMENT MANAGEMENT FOR CLOUD-BASED SYSTEMS,” which is incorporated herein by reference.

### TECHNICAL FIELD

The following discussion generally relates to document management, and in particular to managing access to and creation of executable documents in a cloud-based system.

### BACKGROUND

Whether intentional or unintentional, execution of harmful code is a security vulnerability faced by most computing systems. As modern computing systems grow in size and scope, so too does the potential for malfeasance. Large cloud-based systems are particularly vulnerable due in part to their high volume of user accounts and permission groups working with various levels of access.

Virtual machines or instances are being commissioned and decommissioned regularly, with some dynamically creating or executing code. Cloud-environments typically have many accounts, with most accounts capable of running many executables. Such executables are often distributed widely across computing resources and accounts, which can result in havoc if there is an error or bad code in the distributed executable. A need exists to minimize the risk that harmful executables are introduced into cloud-based computing systems.

### SUMMARY

Systems, methods, and devices of the present disclosure secure executables in a cloud-based environment. An example process includes the step of receiving a first pull request to create an executable document for execution by an instance running in the cloud-based environment. An approval is received for the executable document, and the executable document is stored in a document repository in response to the first pull request and approval of the executable document. A command for a system manager in the cloud-based environment is generated to create the executable document using an interface comprising a console, a command line, or an application programming interface. The command is generated in response to the approval of the executable document. A second pull request is received to create a script in response to the executable document including a call to execute the script. The script is stored in a script repository in response to the second pull request and an approval of the script. The executable document runs in response to a run command from the instance running in the cloud-based environment, and the approved script stored in the script repository runs in response to a call from the executable document.

Various embodiments of the instance include a distributed unit or a central unit. The instance can include a network function of a 5G data and telephone network. The instance runs on a computing resource of the cloud-based environment and executes the executable document on the same computing resource. A send command is issued to propagate the executable document to the instance. The first pull request is triggered in response to new code in the executable document. The script is stored in the script repository of the cloud-based environment in response to the approval of the script. The approval is received in response to the executable document passing an automated check for malicious code.

Another embodiment of an automated process for securing executables in a cloud-based environment includes the step of receiving a first pull request to create an executable document for execution by an instance running in the cloud-based environment. The process further includes storing the executable document in a document repository in response to the first pull request, receiving an approval for the executable document, and generating a command for a system manager in the cloud-based environment to create the executable document. The command is created via a management interface, and the command is generated in response to the approval of the executable document. A second pull request to create a script is received in response to the executable document including a call to execute the script. The script is stored in a script repository separate from the document repository. The executable document runs in response to a run command from the instance running in the cloud-based environment. The script stored in the script repository is run in response to a call from the executable document.

Various embodiments of the instance include a distributed unit, a central unit, or a network function of a 5G data and telephone network. A send command is issued to propagate the executable document to the instance. The script is stored in the script repository of the cloud-based environment in response to an approval of the script. The approval of the executable document is received in response to the executable document passing an automated check for malicious code. The approval of the script is issued in response to the script passing an automated check for malicious code.

Another embodiment of automated process for securing executables in a cloud-based environment includes the step of propagating an executable document from a document repository to an instance in response to an approval of the executable document. The instance includes a distributed unit, a central unit, or a network function of a 5G telephone network. A script is stored in a script repository in response to an approval of the script. The executable document includes a command to execute the script. The executable document is run on the instance in response to a run command on the instance. The script is run from the script repository in response to the command in the executable document.

In various embodiments, the approval of the script is issued in response to the script passing an automated scan for malicious code. The executable document is stored in a document repository in response to a pull request to create the executable document. A command is generated for a system manager in the cloud-based environment to create the executable document stored in the document repository. The executable document is approved in response to the executable document passing an automatic scan for malicious code.

### BRIEF DESCRIPTION OF THE DRAWINGS

FIG. 1 illustrates an example of a 5G data and telephony network using virtualized network functions, in accordance with various embodiments.

FIG. 2 illustrates an example of a 5G data and telephone network using distributed cloud infrastructure, in accordance with various embodiments.

FIG. 3 illustrates an example process for a document management system in a data and telephony network, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

Systems, methods, and devices of the present disclosure manage creation, access, and execution of executable documents in a cloud-based data and telephone network. The telephone network built using virtualized hardware provides numerous benefits in terms of rapid deployment and scalability, but it also presents certain technical challenges that have not been encountered in more traditional wireless networks. Unlike traditional wireless networks that scale through the addition of physical routers, switches, and other hardware, cloud-based networks can scale upwardly and downwardly very quickly as new cloud-based services are deployed or existing services are retired or redeployed. Additional network components can be very quickly deployed, for example, through the use of virtual components executing in a cloud environment that can be very quickly duplicated and spawned as needed to support increased demand. Similarly, virtual components can be de-commissioned very quickly with very little cost or effort when network capacity allows. The virtual components provide substantial efficiencies, especially when compared to prior networks based upon complex interconnections between geographically dispersed routers, servers, and the like.

One challenge that does arise, however, involves managing executable documents on a rapidly evolving, dynamic network. Network components can be commissioned and de-commissioned very rapidly in different geographic locations, and conditions can evolve quickly in various parts of the network that trigger equally rapid decommissioning. Tracking the executables created, modified, requested, or otherwise accessed by ephemeral computing resources and user accounts across a large-scale Radio Access Network (RAN) can be difficult due to the scale of resources involved and the dynamic nature of such networks. Networks that split operations between guest operators and host operators scale the problem of executable management up even more in view of the different user accounts and virtualized devices associated with each host or guest operating entity.

Various embodiments of the present disclosure include a document management system that controls access to and creation of executable documents. Users can request creation of or access to an executable document, and an approval step can serve as a check on creation or access. Users access document tools after the approval step grants the user permission for creation or access on a case-by-case basis. The approval step may be automated or manual. A repository contains approvals and is checked during document creation. Users may not be able to create documents in the systems manager (e.g., SSM in an AWS) without a corresponding approval in a repository.

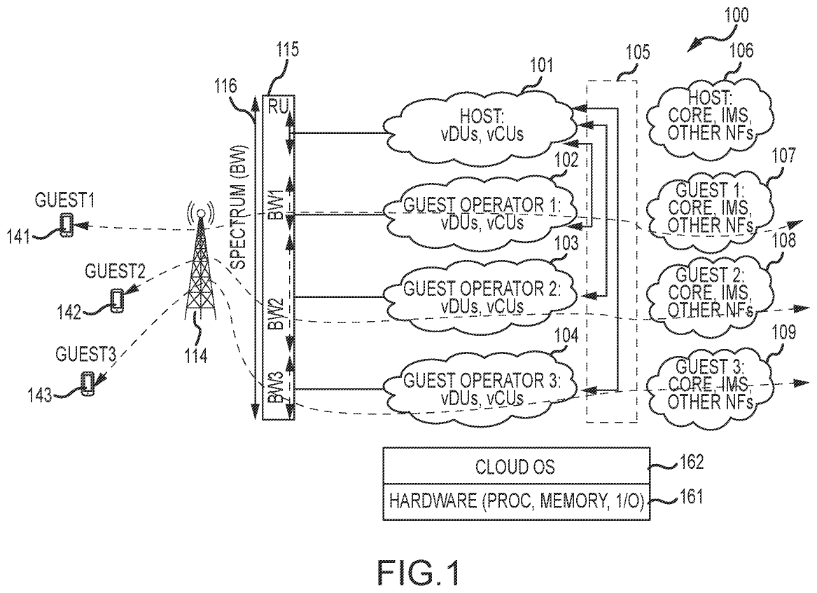

With reference now to FIG. 1, an example of a cellular communication system 100 built on a cloud-based environment is shown, in accordance with various embodiments. Cellular communication system 100 is implemented on cloud-based infrastructure to facilitate dynamic network adaptation. Cellular communication system 100 includes a host operator maintaining ownership of one or more radio units (RUs) 115 associated with a wireless network cell. The example of FIG. 1 depicts a host operator operating a “radio/spectrum as a service (R/SaaS)” that allocates bandwidth on its own radio units for use by one or more guest network operators, though the systems, methods, and devices described herein could be applied to any wireless network using virtualized network services. Examples of guest network operators may include internal brands of the host operator, system integrators, enterprises, external MVNOs, or converged operators. The host and guest network operators may maintain desired network services to support user equipment (UE) 141, 142, 143.

The host and MVNOs may have their own user accounts and permission groups for various roles within cellular communication system 100. User accounts may be provisioned and deprovisioned frequently as virtualized assets come online and go offline. Human users associated with the entities operating cellular communication system 100 typically have accounts and group permissions that should change as the role of human users evolves and changes. Stagnant permissions on user groups tend to result in permission drift, with users having greater access than necessary.

In the example of FIG. 1, each RU 115 communicates with UE 141, 142, 143 operating within a geographic area using one or more antennas 114 capable of transmitting and receiving messages within an assigned spectrum 116 of electromagnetic bandwidth. In various embodiments, guest networks 102, 103, 104 interact with a provisioning plane 105 to obtain desired spectrum across one or more of the RUs 115 operated by the host 101. Provisioning plane 105 allows guest network operators to obtain or change their assigned bandwidths on different RUs 115 on an on-demand and dynamic basis. Network services 107, 108, 109 may be maintained by guest operators and network services 106 may be maintained by host 101. Network services and corresponding user accounts may be scaled up and down in response to network load, and access to executables by user accounts and instances within the system is managed as described herein.

The Open RAN standard breaks communications into three main domains: the radio unit (RU) that handles radio frequency (RF) and lower physical layer functions of the radio protocol stack, including beamforming; the distributed unit (DU) that handles higher physical access layer, media access (MAC) layer, and radio link control (RLC) functions; and the centralized unit (CU) that performs higher level functions, including quality of service (QoS) routing and the like. The CU also supports packet data convergence protocol (PDCP), service data adaptation protocol (SDAP), and radio resource controller (RRC) functions. The RU, DU, and CU functions are described in more detail in the Open RAN standards, as updated from time to time, and may be modified as desired to implement the various functions and features described herein. In the example of FIG. 1, host 101 maintains one or more DUs and CUs (i.e., network functions) as part of its own network. The DU communicates with one or more RUs 115, as specified in the Open RAN standard.

The various network components shown in FIG. 1 are typically implemented using software or firmware instructions that are stored in a non-transitory data storage (e.g., a disk drive or solid-state memory) for execution by one or more processors. The various components shown in FIG. 1 can be implemented using cloud-based hardware 161 and an appropriate operating system 162 such as the Amazon® Web Service (AWS) platform offered by Amazon Inc., although other embodiments could use other cloud platforms or any type of conventional physical computing hardware 161, as desired. For example, system 100 could also run on ServerSpace, Microsoft Azure, Google Cloud Platform, IBM Cloud Services, Kamatera, VMware, or any other suitable cloud service. A combination of cloud services or a private cloud could also be used in the telephone network described herein.

As illustrated in the example of FIG. 1, system 100 includes a host network 101 and one or more guest networks 102, 103, 104. The host network 101 is typically operated by an organization that owns radio equipment and sufficient spectrum (potentially on different bands) to offer 5G capacity and coverage. Host network 101 provides 5G service to connected UEs, and it manages network services available to its own UEs or those of its guest operators. Host network 101 includes at least one DU and at least one CU, both of which will typically be implemented as virtual computing units using cloud resources. Instances of virtual DUs and virtual CUs may be associated with user accounts and other virtualized systems that create or access executables.

Guest networks 102, 103, 104 operated by guest operators can manage their own networks using allocated portions of spectrum 116 handled by one or more of the RUs 115 associated with the host network 101. The guest networks 102, 103, 104 communicate with one or more UEs 141-143 using allocated bandwidth on the host's RU 115. Guest networks 102, 103, 104 may include one or more virtual DUs and CUs, as well as other network services 106, 107, 108, 109 variously associated with user accounts and group permissions, as desired. Generally, one or more guest operators will instantiate its own 5G virtualized network functions (e.g., CMS, vCUs, vDUs, etc.) using cloud-based resources, as noted above. However, various embodiments may operate outside of cloud-based environments.

Each RU 115 is typically associated with a different wireless cell that provides wireless data communications to user devices 141-143. RUs 115 may be implemented with radios, filters, amplifiers and other telecommunications hardware to transmit digital data streams via one or more antennas 114. Generally, RU hardware includes one or more processors, non-transitory data storage (e.g., a hard drive or solid-state memory), and appropriate interfaces to perform the various functions described herein. RUs are physically located on-site with the transmitter/antenna 114, as appropriate. Cloud-based data and telephone networks can make use of any number of wireless cells spread across any geographic area, each with its own on-site RU 115.

RUs 115 support wireless communications with any number of user devices 141-143. UE 141-143 are often mobile phones or other portable devices that can move between different cells associated with the different RUs 115, although 5G networks are also widely expected to support home and office computing, industrial computing, robotics, Internet-of-Things (IoT), and many other devices. While the example illustrated in FIG. 1 shows one RU 115 for convenience, a practical implementation will typically have any number of virtualized RUs 115 that can each be individually configured to provide highly configurable geographic coverage for a host or guest network, if desired.

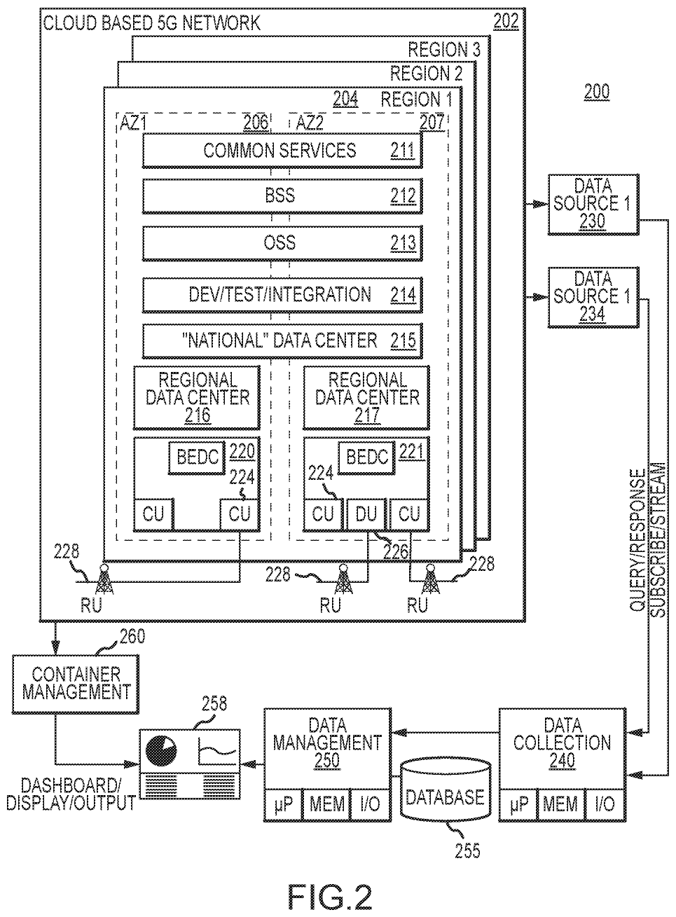

With reference to FIG. 2, a 5G wireless network 202 can be implemented using cloud-based computing system 200. In the example of FIG. 2, wireless network 202 encompasses data processing services supporting multiple regions 204, each having one or more availability zones (AZs) 206, 207 each acting as a separate data center with its own redundant power, network connectivity and other resources as desired. In some implementations, the various AZs operating within the same region will provide redundancy in the event a neighboring AZ fails or is overloaded. The example of FIG. 2 illustrates three regions, with region 204 having two AZs 206, 207, although other embodiments could include any number of regions and AZs providing any number of services and resources. The regions and zones are often described herein with reference to geographic locations, but in practice the regions and zones could be equivalently organized based upon customer density, user density, expected network demand, availability of electric power or bandwidth, or any other factors. As noted above, it will still be necessary to deploy radio units (RUs) within broadcast range of end users. But by implementing the other functions of the network using virtualized hardware operating within a cloud-type architecture, geographic restrictions upon the network 202 can be greatly reduced. This can provide substantial efficiencies in deployment and expansion of network 202, while also allowing for more efficient use of computing resources, data storage and electric power.

In example of FIG. 2, a network operator maintains ownership of one or more RUs 228, 229 associated with a wireless network cell. Each RU 228, 229 communicates with UE operating within a geographic area using one or more antennas. In the example illustrated in FIG. 2, common services (e.g., billing, guest network allocation, etc.) can be performed in a shared service 211 across the AZs 206, 207. Typically, these shared services will be implemented within a common virtual private cloud (VPC) operating within the cloud environment. Similarly, shared VPC systems can support business support system (BSS) 212, operational support services (OSS) 213, development/test/integration features 214, and/or the like across the entire region. A region wide data center (identified as a “national” data center 215 in FIG. 2) could be implemented in a shared VPC across AZs 206, 207, if desired, with subordinate data centers (e.g., “regional” data centers 216, 217) being separated into different VPCs for each of the AZs 206, 207. Additional levels of data centers could be provided, if desired, and/or the different data center functions could be differently organized in any number of equivalent embodiments. The various data centers could provide any number of services such as IP multimedia services (IMS), 5G core services, and/or the like.

In the example of FIG. 2, each AZ 206, 207 includes one or more breakout edge data centers (BEDCs) each supporting a local zone (LZ) with one or more RUs. The BEDCs are ideally organized for very low latency to provide best possible throughput and low latency to the various user equipment operating within the local zone. BEDCs 220, 221 will typically implement one or more CUs in accordance with the 0-RAN specifications. BEDCs may also implement user plane functions that handle user data sessions for gaming, streaming, and other network services, as desired. Again, any number of BEDCs and other data centers may be implemented using any number of different or shared VPCs in the cloud environment, as desired.

As noted above, each of the various network components shown in FIG. 2 are typically implemented using software or firmware instructions that are stored in a non-transitory data storage (e.g., a disk drive or solid-state memory) for execution by one or more processors within the VPC. VPCs may provide any number of additional features to support the data handling functions of the system, including redundancy, scalability, backup, key management, and/or the like.

As noted above, the various components of network 202 can be implemented using virtual private clouds (VPC) or other virtual hardware components. Each of these VPCs will typically produce data during operation that indicates status, performance, capacity or any number of other parameters. It is generally desired to monitor the status of network 202. One way to track network status is to process the large amount of data produced by the various modules and components to generate dashboards or other reports that can be viewed by an operator. Operating data can also be used to adjust the configuration or operation of the network, as desired.

In various embodiments that make use of a data pipeline, one or more data sources 230, 234 can be provided to obtain raw data from one or more of the components of network 202. Data sources 230, 234 may receive data as part of a data stream, if desired. Other data sources 230, 234 may receive and maintain log data or the like from one or more associated components, as appropriate. Any number of streaming or query-based data sources 230, 234 may be deployed within system 200, as desired.

In the example shown in FIG. 2, data source 230 may be configured in accordance with the KAFKA software tool available from the Apache Software Foundation. The software may be installed to execute on any sort of hardware, including a conventional computer server with a processor, memory and input/output interfaces to the appropriate components of network 202. Equivalently, data source 230 may be implemented using a virtual private cloud or virtual server system as part of a cloud provider, as desired.

The streaming data source 230 will typically be configured to receive real-time data (or near real time data, accounting for some delays inherent in data processing, communications, and the like) from one or more components of network system 202. Streaming data may be particularly useful for network components that generate substantial amounts of real-time data (e.g., performance measurements, etc.). Data source 230 will be configured to receive the data stream from the monitored component, typically as a consumer process executed by the data source 230. Other embodiments may use other tools, and/or may be configured in any other manner.

If desired, multiple components of 5G wireless system 202 could supply KAFKA or other streaming data to a common data source 230. DU 226 and CU 224 instances of network 202, in particular, provide substantial amounts of real-time data that can be very efficiently pipelined through a combined streaming data source 230, as appropriate.

In the example of FIG. 2, data source 234 is shown as a query-based source that collects data from one or more components of network 202. Generally speaking, data handled by query-based sources tend to be less reliant upon real-time delivery for status updates or the like. Log data, fault metrics, performance metrics, and other types of time-series data may be particularly well-suited for query-type collection.

In one embodiment, query-based data source 234 is implemented using PROMETHEUS software or the like, which allows for a pull-based data collection model using HTTP-type messaging. In this example, the PROMETHEUS software is configured to run on a computer server (e.g., implemented with conventional hardware or cloud-based resources) that queries the monitored components according to any desired time schedule to receive data. The data received in response to the queries may be locally cached in any sort of non-transitory memory (e.g., solid state memory, magnetic or optical memory, cloud-based sources, and/or the like) for subsequent retrieval and processing as desired. Query-based data sources may be particularly useful in tracking data produced by the various DUs, CUs, and other components of the network that produce substantial amounts of log data. Typically, each component is configured to write its output/log data to the data source 234, as desired.

Although FIG. 2 illustrates one streaming data source 230 and one query-based data source 234, in practice any number of different data sources could be used to monitor any number of different components of network 202. Some components may provide streaming data and query based data to multiple data sources, if desired.

A data collection system 240 suitably communicates with one or more data sources 230, 234 to obtain streaming and/or query-based data. In various embodiments, data collection system 240 subscribes to one or more KAFKA feeds or other streaming services associated with data sources 230. Data collection system 240 may also be configured to place queries to PROMETHEUS or other query-based data sources 234, as desired. Data collection system 234 typically receives the requested and/or subscribed data, formats and/or filters the received data as appropriate, and forwards the collected data to a data management system 250 for storage, reporting, or any other further processing as desired. In various embodiments, the data collection system 240 receives data in JSON or similar format, appends source and/or service location information as tags or the like, and pushes the tagged data to the data management system 250 (using, e.g., HTTP structures or the like). Generally, the data collection system will be configurable to specify batch sizes, delivery times, and/or other parameters for obtaining query based data and/or for pushing collected data to the data management system 250. Some embodiments may also filter the received data as desired to remove unwanted or unnecessary data that would otherwise consume excess storage in data management system 250. Other embodiments may perform additional monitoring, as needed.

Data management system 250 is any data processing system capable of receiving the data from data collection system 234 and presenting the collected data for further use. In various embodiments, data management system 250 is a computer server implemented with conventional or virtual cloud-based hardware executing DATADOG or similar software for managing collected data. In various embodiments, data management system 250 stores received data in a database 255 for later retrieval, as desired. Data management system 250 may also provide reports to human and/or automated reviewers. Output 258 can be displayed visually in dashboard form, for example. Output 258 can be in a machine-readable form such as a tagged data store.

The example illustrated in FIG. 2 shows data sources 230, 234 as obtaining aggregated data from components of network 202. This points out the relationships between the sources of data, data collection system 240, and data management system 250. In a practical implementation, however, data collection system 240 may be equivalently configured to subscribe to live data streams or to directly poll components of network 202, without the need for separate data aggregation systems 230, 234.

In another equivalent embodiment, the functionality of data sources 230, 234 is designed into the components of the network 202 themselves, thereby obviating the need for separate aggregation. One or more components of network 202 may be configured to supply a KAFKA or similar data stream directly to data collection system 240, for example. Similarly, data collection system 240 can run queries directly against components of system 202, if desired, without the need for intervening processing modules. Processed data is provided for delivery to the data management system 250 described above. In various embodiments, output feature 258 provides data to the data management system 250 using HTTP structures (e.g., HTTP “PUT” features), JSON, unstructured data, or the like. Other embodiments could implement the various functions and components described herein in any number of equivalent arrangements.

In operation, then, a data management system 250 obtains streaming or query-based data from one or more components of a 5G wireless network operating within a cloud-based computing environment. The data is obtained directly from the component, or via intervening data source systems 230, 234 that aggregate data from multiple data sources within the network 202. Collected data is tagged and filtered as desired, and the resulting data is delivered to a data management system for storage, reporting, or other actions as appropriate. Other embodiments may include other processing modules in addition to those illustrated, and/or may provide the various features and functions described herein using different (but equivalent) arrangements of processing modules and features, as desired.

Document management systems described herein can access data management system 250 to facilitate automated evaluation of executable documents and associated scripts. Automated approval or denial of access can result in response to system conditions identifiable through the aggregated and tagged data of data management system 250.

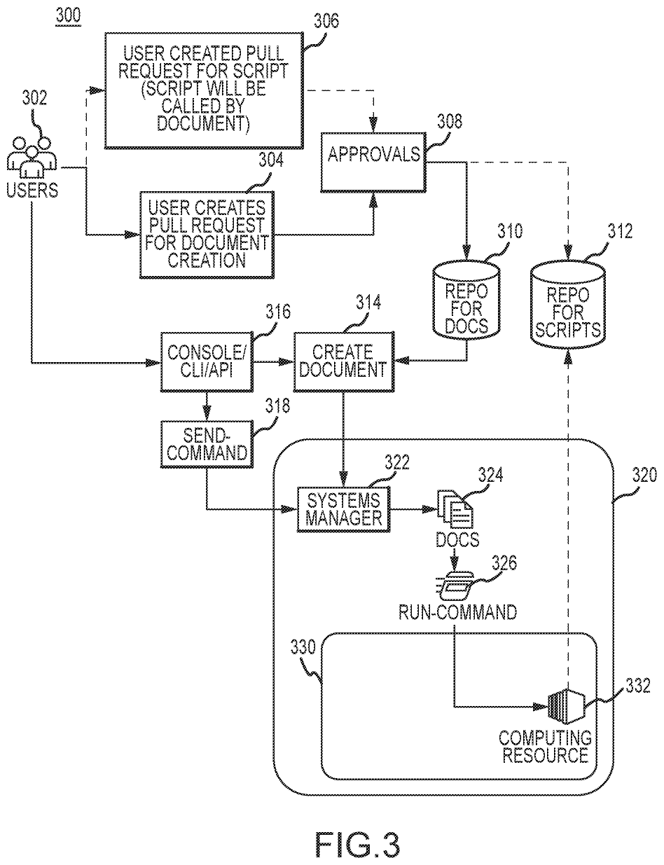

With reference to FIG. 3, process 300 for securely creating, storing, and managing access to executable documents is shown, in accordance with various embodiments. Process 300 manages access by user accounts 302 to create or execute documents. User accounts can be dynamically generated accounts or static accounts as instances of network functions are created and retired in various availability zones across the data and telephony network. User accounts 302 may be system accounts, group accounts, user login accounts, or any other type of account-assignable permissions to read, write, or execute files.

In the example of FIG. 3, process 300 can run on network 202 of FIG. 2 to manage access to executable documents. SSM documents define actions to be taken with respect to AWS resources, which can change the configuration of a telephone and data network running on the AWS cloud-based system. While the depicted example embodiment of FIG. 3 is configured to run using AWS cloud services and is described using terminology such as SSM, document, and Elastic Compute Cloud (EC2), other embodiments could equivalently run on other cloud platforms.

User accounts 302 may create a pull request for documents creation (Step 304). The request may be formatted in JSON or in any other suitable data structure for ingestion or processing. The pull request may be an event triggered in response to an engineer or process pushing new code (e.g., a script or executable document) into a repository. In that regard, a pull request is triggered in response to the creation of new or revised code. The user account uses a creation interface 316 to create a document (Step 314). Creation interface 316 may be, for example, a management console, a software development kit (SDK), a command-line interface (CLI), an application programming interface (API), or other suitable tools for creating an executable document. A send-command 318 runs via creation interface 316 and propagates approved documents to target instances 330 for execution. For example, a virtual distributed unit can receive an executable document in response to being commissioned as an instance of system 200.

In various embodiments, executable documents can be created, modified, deleted, or executed using process 300. The executable document is stored in document repository 310 after an approval step. Deletions from the document repository 310 may also require an approval step. An approver reviews the document and can approve, reject, or edit the document (Step 308) before the document is stored in repository 310 for later access by instance or user accounts. Review may be conducted by an individual independent from the user or virtualized system associated with user account 302. Approvals may be automated or manual based on a predetermined criteria. Approval can include review of network status facilitated by data management system 250 of FIG. 2. System status of the wireless network can include system load or outages, instance load or outages, availability zone load or outages, data center load or outages, for example. Approval can be based on data associated with the requesting user account such as account type, account age, account role, membership in permission groups, access permissions available to the account, or other account data.

In some embodiments, documents that contain low-risk commands such as read commands, status checks, polling commands, or other commands issued against low-priority assets may be approved automatically. The system can automatically approve a request if the request does not pose a data loss or denial of service risk. Higher risk commands such as write commands, sensitive access commands, elevated execution commands, commands to modify security controls, system configuration commands, or other potentially high-impact commands can trigger manual approval.

Users can create a pull request for a script that is called or otherwise accessed by an executable document (Block 306) in some embodiments. Scripts can be written using any program language or syntax suitable for scripting and suitable for execution. The pull request for a script is generated in response to one or more executable documents attempting to execute the script.

In various embodiments, scripts are stored in repository 312 after review and approval. Approvals may be automated or manual based on a predetermined criteria similar to those described above with reference to executable documents. For example, scripts that contain only read commands, status checks, pattern recognition, polling commands, or other commands issued against low-priority assets may be approved automatically if the request does not pose a data loss or denial of service risk. Approved scripts may be stored in an instance 330 or other virtual computing asset running on cloud-computing resources 332 in advance of execution.

Various embodiments respond to approval of a document by entering the document into cloud-based environment 320 using systems manager 322. In the depicted example of FIG. 3, the document can be created as document 324. Document 324 may be used to automate deployment, configure assets, or otherwise automate tasks during execution. Document 324 may execute a run command 326 to execute a script, function, program, or other executable on an instance 330 running on a cloud-computing resource 332. Since the documents in document repository 310 are approved, any document run from the document repository 310 has already been reviewed for errors or potentially malicious code. Since the scripts in script repository 312 are approved, any script run from the script repository 312 has already been reviewed for errors or potentially malicious code. Restricting execution of documents to documents from the sterilized document repository 310 (and scripts from the sterilized script repository 312) tends to inhibit the execution of malicious code in a rapidly changing environment.

By managing access to document creation and script creation in cloud-based environment 320, process 300 tends to mitigate execution of malicious code in cloud-based environment 320. Document executables are reviewed and approved before introduction into cloud-based environment 320, which tends to prevent introduction of malicious documents into cloud-based environment 320. Scripts are also reviewed and approved before introduction into cloud-based environment 320, which tends to inhibit introduction of malicious scripts into cloud-based environment 320. The likelihood of malicious code being executed in the cloud-based data and telephony network is reduced by enforcing that instance run executables retrieved from the sterilized document repository or the sterilized script repository.

Benefits, other advantages, and solutions to problems have been described herein with regard to specific embodiments. Furthermore, the connecting lines shown in the various figures contained herein are intended to represent exemplary functional relationships or couplings between the various elements. It should be noted that many alternative or additional functional relationships or connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used herein, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. An automated process for securing executables in a cloud-based environment, comprising:
receiving a first pull request to create an executable document for execution by an instance running in the cloud-based environment;
receiving an approval for the executable document;
storing the executable document in a document repository in response to the first pull request and the approval of the executable document;
generating a command for a system manager in the cloud-based environment to create the executable document using an interface comprising a console, a command line, or an application programming interface, wherein the command is generated in response to the approval of the executable document;
receiving a second pull request to create a script in response to the executable document including a call to execute the script;
storing the script in a script repository in response to the second pull request and an approval of the script;
running the executable document in response to a run command from the instance running in the cloud-based environment; and
running the approved script that is stored in the script repository in response to a call from the executable document.

2. The automated process of claim 1, wherein the instance comprises a distributed unit or a central unit.

3. The automated process of claim 1, wherein the instance comprises a network function of a 5G data and telephone network.

4. The automated process of claim 3, wherein the instance runs on a computing resource of the cloud-based environment, wherein the instance executes the executable document on the computing resource of the cloud-based environment.

5. The automated process of claim 1, further comprising issuing a send command to propagate the executable document to the instance.

6. The automated process of claim 1, wherein the first pull request is triggered in response to new code in the executable document.

7. The automated process of claim 1, wherein the script is stored in the script repository of the cloud-based environment in response to the approval of the script.

8. The automated process of claim 1, wherein the approval is received in response to the executable document passing an automated check for malicious code.

9. An automated process for securing executables in a cloud-based environment, comprising:
receiving a first pull request to create an executable document for execution by an instance running in the cloud-based environment;
storing the executable document in a document repository in response to the first pull request;
receiving an approval for the executable document;
generating a command for a system manager in the cloud-based environment to create the executable document using a management interface, wherein the command is generated in response to the approval of the executable document;
receiving a second pull request to create a script in response to the executable document including a call to execute the script;
storing the script in a script repository separate from the document repository;
running the executable document in response to a run command from the instance running in the cloud-based environment; and
running the script stored in the script repository in response to a call from the executable document.

10. The automated process of claim 9, wherein the instance comprises a distributed unit or a central unit.

11. The automated process of claim 9, wherein the instance comprises a network function of a 5G data and telephone network.

12. The automated process of claim 9, further comprising issuing a send command to propagate the executable document to the instance.

13. The automated process of claim 9, wherein the script is stored in the script repository of the cloud-based environment in response to an approval of the script.

14. The automated process of claim 9, wherein the approval of the executable document is received in response to the executable document passing an automated check for malicious code.

15. The automated process of claim 9, wherein the approval of the script is issued in response to the script passing an automated check for malicious code.

16. An automated process for securing executables in a cloud-based environment, comprising:
propagating an executable document from a document repository to an instance in response to an approval of the executable document, wherein the instance comprises a distributed unit, a central unit, or a network function of a 5G telephone network;
storing a script in a script repository in response to an approval of the script, wherein the executable document includes a command to execute the script;
running the executable document on the instance in response to a run command on the instance; and
running the script from the script repository in response to the command in the executable document.

17. The automated process of claim 16, wherein the approval of the script is issued in response to the script passing an automated scan for malicious code.

18. The automated process of claim 16, further comprising storing the executable document in a document repository in response to a pull request to create the executable document.

19. The automated process of claim 18, further comprising generating a command for a system manager in the cloud-based environment to create the executable document stored in the document repository.

20. The automated process of claim 16, further comprising approving the executable document in response to the executable document passing an automatic scan for malicious code.
